(19) United States
(12) Patent Application Publication
(10) Pub. No.: US 2012/0234666 A1
(43) Pub. Date: Sep. 20, 2012

(54) APPARATUS AND METHODS FOR WATER TREATMENT

(76) Inventor: Gordon Ward Rogers, Santa Barbara, CA (US)

(21) Appl. No.: 13/422,658

(22) Filed: Mar. 16, 2012

Related U.S. Application Data
(60) Provisional application No. 61/453,442, filed on Mar. 16, 2011.

(51) Int. Cl. C02F 1/14

(52) U.S. Cl. 203/10; 202/233; 202/155; 202/234; 202/176

(57) ABSTRACT

Methods and apparatuses for the evaporation and condensation of water by utilizing latent heat of condensation and solar heating is provided. Various embodiments include a module that may be associated with a body of water and incorporate first and second dendritically liquid receiving channels, a dome, a lower chamber and an upper chamber. The first channel conducts water from the body of water to a reservoir located within the module. The second channel is in heat exchange relationship with the first liquid receiving channel and conducts water from the reservoir to the exterior of the module below the reservoir. The dome encloses the top of the reservoir and forms a vaporization chamber. An exit drain in the vaporization chamber leads to a collection channel for conducting demineralized condensate out of the module. Still other embodiments utilize at least two membrane layers having a plurality of dendritically-configured and/or nested channels.

### CROSS-REFERENCE TO RELATED APPLICATIONS

This application claims priority to U.S. Provisional Application Ser. No. 61/453,442, filed Mar. 16, 2011, the contents of which, including any appendices attached thereto, is hereby incorporated herein by reference in its entirety.

### BACKGROUND

1. Field of Invention

The present invention relates generally to improved apparatuses and methods for the treatment of water. In particular, water that is initially contaminated, whether by salt, fluorine, or other minerals, may be purified prior to use by plants, animals and humans according to various embodiments.

2. Description of Related Art

All plants and animals need clean water to survive on a nearly daily basis. Drought on our planet has been an ongoing issue challenging the survival of humans and ecologies throughout history and in many places throughout the world. Desertification forces people from land that once produced food and that was hospitable. The lack of a reliable source of clean drinkable water causes poverty or loss of life. Most of the population of the planet lives close to an ocean or other body of non-potable water. These considerations have caused water, and the lack thereof, to be the center of great public concern and potential conflict. Recent studies have shown that an estimated forty percent of the last thousand years have been droughts. Many cultures have vanished because of the lack of water. Yet unusable water sources abound, or are uneconomic to purify.

Yet existing means of purification have associated high energy costs, both in terms of the energy needed to construct the facility which processes the water being purified and in the amount of energy used in the purification process itself. Thus, a need exists for improved apparatuses and methods that reduce energy costs by taking advantage of the simple evaporative and condensation-related properties of water. The present invention addresses this need in multiple ways, as will be described in further detail below.

### BRIEF SUMMARY

Various embodiments of the present invention address the above needs and achieve still other advantages by providing apparatuses for the evaporative demineralization of water by utilizing latent heat of condensation and solar heating for energy of vaporization. Various embodiments of the present invention also provide methods of testing the efficacy of such apparatuses.

In accordance with the purposes of various embodiments as described herein, a solar powered desalination apparatus for reducing the salinity of salt water is provided. The apparatus comprises a first membrane layer and a second membrane layer, wherein the first membrane layer is contacting the second membrane layer thereby forming a plurality of channels, including a first channel and a second channel. The first channel is configured to receive the salt water for desalination; a first area connected to the first channel is configured to increase the temperature of the salt water so as to cause evaporation of the salt water upon the first area being exposed to solar generated light; and the second channel comprises a first portion and a second portion, the first portion configured to convey condensed water having a higher salinity from said evaporation of said salt water and the second portion configured to convey condensed freshwater.

In accordance with the purposes of various embodiments as described herein, another modular apparatus for the evaporative demineralization of water is provided. The modular apparatus provides at least partially demineralized water by utilizing latent heat of condensation and solar heating for energy of vaporization. The modular apparatus thus comprises a multilayer module having one or more parameters controllable with respect to that of a body of mineral containing water. The module itself comprises: a first dendritic liquid receiving channel having an entrance port in communication with the exterior of the module, the entrance port being oriented so as to drain toward an exit drain with minimal channel angle with respect to the exit drain; and a second dendritic liquid receiving channel in heat exchange relationship with the first dendritic liquid receiving channel, the second dendritic liquid receiving channel being oriented so as to drain toward an exit drain with a channel angle with respect to the exit drain. The module further comprises a dome above the reservoir enclosing the reservoir and forming a vaporization chamber having an inner domed condensation surface and a lower condensate-collecting surface, the condensate-collecting surface having an exit drain in communication with a collection channel for conducting demineralized condensate out of the module, wherein at least the first dendritic liquid receiving channel is in thermal contact with a riser on the focal axis of the modular apparatus.

In accordance with the purposes of various embodiments as described herein, a method of using an apparatus for the evaporative demineralization of water is provided. The method comprises the step of placing at least one module exposed to the sun or other source of radiant energy onto a comparatively cold body of mineral containing water to float or level the module, whereby an evaporation cycle is performed by: (A) allowing a portion of mineral-containing water to flow into a first dendritically formed liquid receiving channel and into the reservoir and to flow from the reservoir into a second dendritically formed liquid receiving channel until the water level in the reservoir rises and blocks or reaches the exit port of the first dendritically formed liquid receiving channel; (B) allowing water in the reservoir to be heated by radiant energy radiating through the dome into the evaporation chamber causing water in the reservoir to evaporate, condense on the condensing surface, collect on the floor of the chamber's capillary bed channeled surface, and flow into the exit drain to fill the collection channel whereby condensate exits the module and the filling of the collection channel blocks or is assisted in exiting exit of vapor's flow by virtue of its flow, from the evaporation chamber; (C) introducing higher concentration mineralized water in the reservoir during evaporation proceeding as effluent to flow into the second dendritically formed liquid receiving channel and out of the module through the exit port in communication with the exterior of the module below the reservoir; and (D) during flow of mineral-containing water and effluent into and from the module, the first and second dendritically formed liquid receiving channels are continuously filled respectively with mineral-containing water and effluent in heat exchange relationship as the evaporation cycle is repeated within the module and demineralized water is continuously collected through the collection channel.

### BRIEF DESCRIPTION OF THE SEVERAL VIEWS OF THE DRAWING(S)

The accompanying drawings incorporated herein and forming a part of the specification, illustrate several aspects of the present invention and together with the description serve to explain certain principles of the invention. In the drawings:

FIG. 1 shows an exploded view of a cell 100 in accordance with various embodiments;

FIG. 2 is a vertical cross section of the cell 100 of FIG. 1;

FIG. 3A is a top elevational view of an array of a plurality of the cells 100 illustrated in FIGS. 1 and 2;

FIG. 3B is a vertical cross sectional view of the array of cells 100 of FIG. 3A;

FIG. 3C is a top view of the array of cells 100 of FIG. 3A;

FIG. 4 is a top elevational view of cell 100 mounted on a non-horizontal surface in accordance with various embodiments;

FIG. 5 is a top elevational view of a cup and mirror layer of cell 100 in accordance with various embodiments;

FIG. 6 is a top elevational view of a cell 200 in accordance with various embodiments;

FIG. 7 is a side perspective view of the series of thin channels exiting the cell 200 of FIG. 6, configured to separately collect the effluent of increased salinity concentration and the fresh product water.

FIG. 8A is a top view of a unitary dendritic flow through the series of thin channels of FIG. 7;

FIG. 8B is a top view of a double dendritic configuration, analogous to the unitary flow of FIG. 8A;

FIG. 9 is an bottom perspective view, illustrating the slightly angled “leveling” of cell 200 according to various embodiments, such that either an uphill or downhill “flow” may be produced; and

FIG. 10 is a top perspective view of the illustration of FIG. 9.

### DETAILED DESCRIPTION OF THE INVENTION

Various embodiments of the invention described herein pertain to water purification. In particular, the various embodiments relate to a scalable means for the purification, including desalination, of water by use of multiple layers of thin plastic. In various embodiments, these layers are convoluted into bubbles and manifolds forming channels, thermal transfer interfaces and containment, as well as thermal isolation in contained gas volumes. Various implementations of the invention will now be described by way of example and with reference to the drawings. As the skilled reader will realize, the underlying principles of the various embodiments of the invention as described herein can be used not only for water desalination and purification, but also in a wide range of other applications, such as atmospheric carbon dioxide scrubbing, industrial and mining cleanup and food production.

Unless otherwise indicated, all numbers expressing quantities of dimensions such as length, width, height, and so forth as used in the description are to be understood as being modified in all instances by the term “about.” Accordingly, unless otherwise indicated, the numerical properties set forth in the description are approximations that may vary depending on the desired properties sought to be obtained in embodiments of the present invention. Notwithstanding that the approximate numerical ranges and parameters setting forth the broad scope of embodiments of the present invention, the numerical values set forth in the specific examples are reported as precisely as possible. Any numerical values, however, inherently contain certain errors necessarily resulting from error found in their respective measurements.

### Structure of Various Embodiments of the Invention

### Various Embodiments of Cell 100

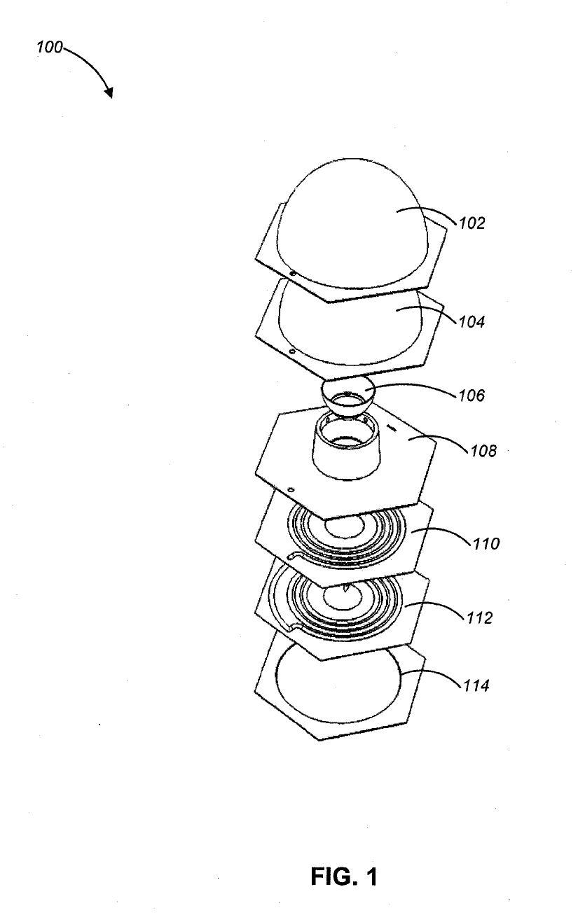

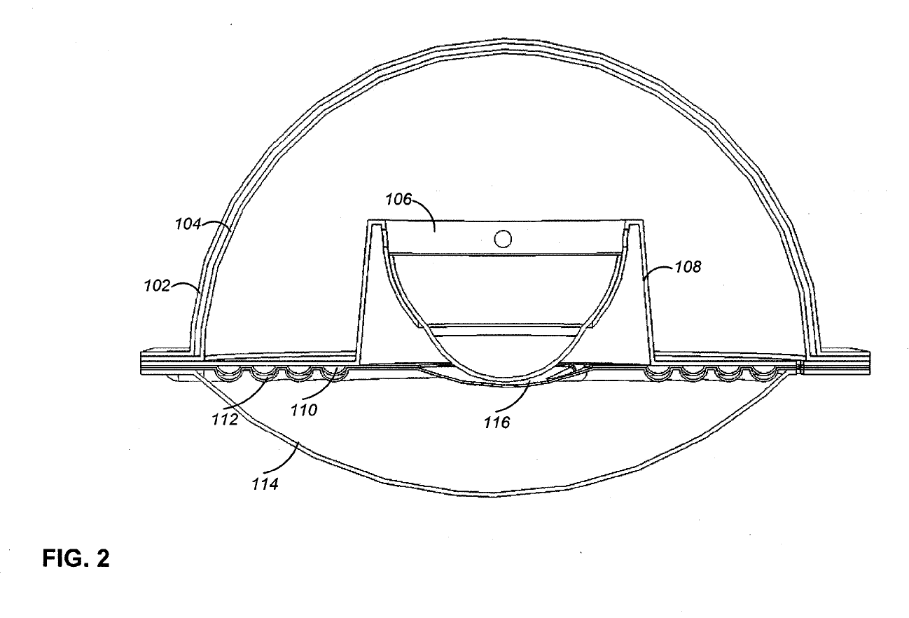

FIG. 1 shows an expanded view of various embodiments of a single cell (100), while FIG. 2 shows a vertical cross sectional view of the same cell in its assembled configuration. As will be discussed in further detail below, the water flow through the cell is actuated by both gravity and vacuum exerted on water flowing between the top external surfaces of neighboring domes, not simply by merely covering the dome tops. A low vacuum can be provided by water flowing past the exit port on the lower layers. As such, it is desirable, as will be described in further detail later herein, to construct the cell such that passageways therein may be adjusted so as to provide a sloped surface for facilitating the flow of water there-through.

Remaining with FIGS. 1 and 2, various embodiments of the cell (100) may include a number of layers. An outer dome (102) provides thermal isolation for the cell (100). An inner dome (104) forms an evaporative containment vessel. The inner dome layer (104) is thermally insulated from airflow above the cell (100) by the outer dome (102) located above. Some embodiments that are used in environments where external convection is low, such as areas with typically low winds, may have no outer dome (102). As the skilled person realizes, the insulating layer formed between the outer dome (102) and the inner dome (104) constitutes, amongst other things, a trade-off between these effects and reflective losses due to multiple surfaces. Idealized insulation values are dictated by the type of gas that is used between the outer dome (102) and the inner dome (104). The interlayer gas volume is maintained distinct from the interior of the inner dome (104). In a sense, the insulating gas can be thought of as the ‘hot attic’ of the dome. This may be formed by a mating array or layer above the evaporative containment cell, as will be described in further detail below.

According to various embodiments, the double-dome structure of cell (100) allows pre-heating of the inner dome (104) to preclude condensation energy losses there. This preclusion of convection cooling on the internal surface exacerbated by air movement in the absence of the external dome is considered herein to be a preferable trade-off against the alternative of any losses incurred by the necessitated heating of the interstitial space between the outer dome (102) and the inner dome (104). An additional feature of this approach is that it automatically changes the cell's (100) volume and thereby its natural water level. This feature can be supplemented in certain embodiments by similar sealed air bladders below the operating waterline not only to perform the thermal isolation of coils, as will be discussed below, but in order to flush accumulated minerals when the cell cools at night and the water level rises to above the operating height by increasing the head or by decrease in buoyancy. These terms, at least in part, define the long-term operability of the system.

As may also be understood from FIGS. 1 and 2 collectively, an evaporative structure (106) is provided below the inner dome (104) according to various embodiments. In certain embodiments, the evaporative structure (106) may be porous, water insoluble, made of food-grade materials, and capable of sustained temperatures approaching and/or exceeding 100 degrees centigrade. Other embodiments may use calculated target temperatures achieved substantially lower than 100 degrees centigrade or may use open water approaches not involving an evaporative surface area enhancer, which may reduce mineral salt deposition. In still other embodiments, target temperatures may be any of a variety of temperature at, below, above, or even far exceeding the aforementioned 100 degrees centigrade, as may be desirable for various applications.

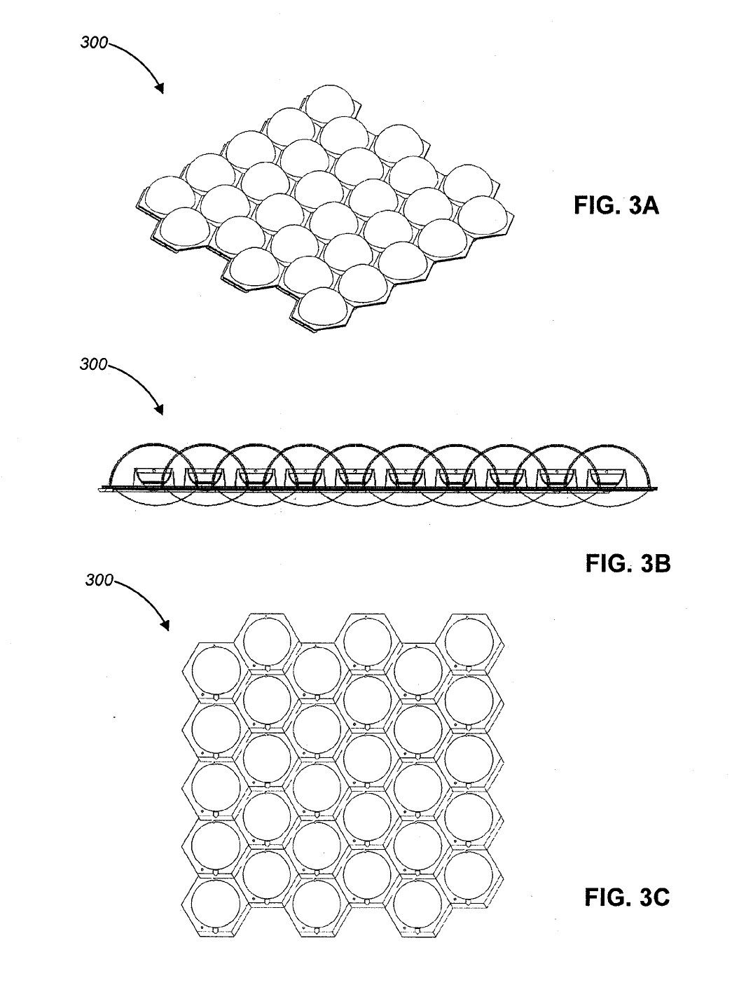

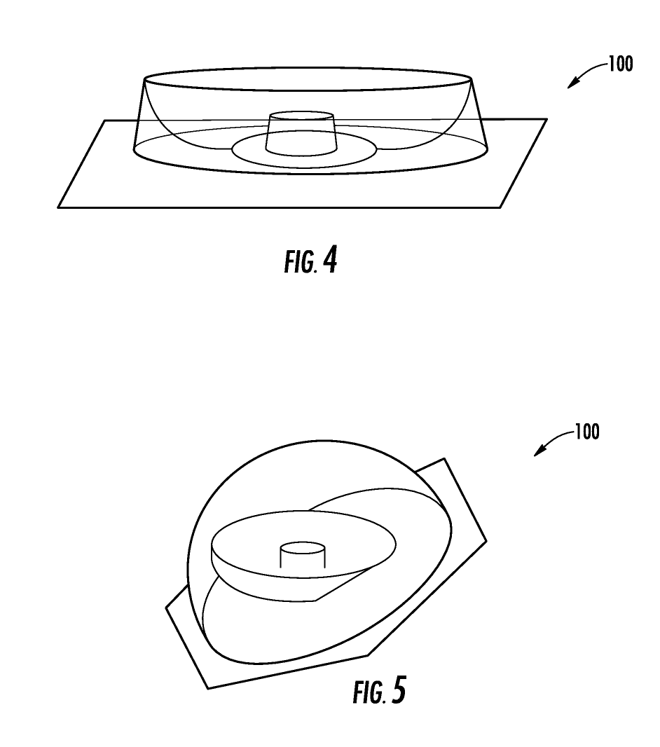

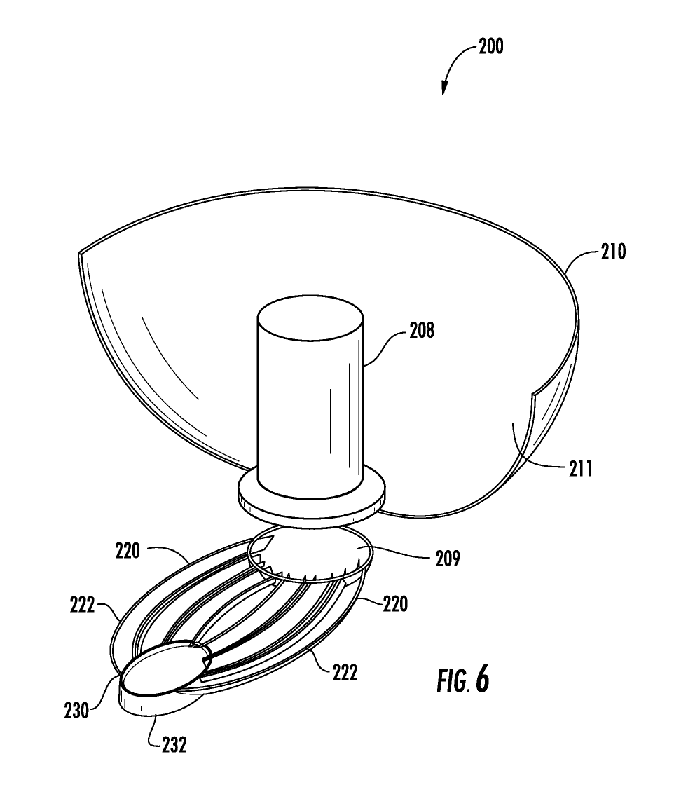

Turning now to not only FIGS. 1 and 2, but also FIGS. 3 and 4, an elevated cup (108) is illustrated according to various embodiments of cell (100). In these and other embodiments, the cup (108) may have an interior bottom formed by the two sheet layers below (110,112) and additionally accessed by the end point of a spiral channel with incoming water located one layer below (110). As will be described in further detail below with regard to alternative embodiments, the spiral channel may be formed in different shapes (e.g., dendritic, elongate, or otherwise), as may be desirable for particular applications. In these and still other embodiments, however, it should be understood that the layer (108) forming the solar collector focusing upon the cup may be shaped substantially as a concave mirror, which may be configured to focus on the evaporative region, including the cup, in some embodiments. In this manner the layer (108) is configured to be otherwise in contact and to seal with the layer (110) below it, such that the layer (108) is thermally conductive and in thermal contact with the common (mixed) incoming and outgoing reservoirs, as will be described in further detail below.

According to various embodiments of cell (100), the elevated cup layer (108) may be non-porous, water insoluble and of food-grade material. Certain embodiments may also incorporate a reflective coating in mirrored applications, with the coating being formed on the layer's upper surface and being capable of sustained temperatures at, above, and even exceeding 100 degrees centigrade. It should be understood that the elevated cup layer (108) is configured to be thermally conductive and in thermal contact with the common (mixed) incoming and outgoing reservoirs, such that the reservoir is maintained at or above the operating temperature (e.g., at, below, or exceeding 100 degrees centigrade, as previously described) of the cell in at least the vicinity of the layer (108). In these and still other embodiments, the mirror may be formed with a slot oriented toward the area of the entrance of the incoming water under the boundary of the dome and a cap and channel for steam direction toward cooler regions of the condensation surface.

According to various embodiments of cell (100), below the cup layer (108) is an incoming spiral channel layer (110). The spiral channel has a curvature that is the same as the curvature of an outgoing spiral channel in the outgoing spiral channel layer (112) below. The incoming spiral channel is principally contained by the spiral below, except at its endpoints on the output end which terminate outside the thermal containment bubble created by layer below when present on the cellular level, and of the end closest to the center of the cell which terminates in an opening onto the bottom of the central cup (108). Since the top of the incoming water channel serves as the bottom of the condensation chamber (e.g., forms a ceiling/floor relationship between layers), a thermal exchange boundary is created in these and still other embodiments. By forming a coil of input water thermally interfacing with the floor of the condensation chamber, the temperature of the cold, incoming water is raised jointly by condensation on the interface and post processes effluent temperatures exposure.

Remaining with FIG. 2, according to various embodiments, below the incoming spiral channel layer (110) is an outgoing spiral channel layer (112), which forms the outgoing channel by means of a spiral conduit where the layer (112) is otherwise in contact with the above layer (110) forming seals around the perimeter of the spiral channel and in a central depression forming the floor of the cup (108) two layers up. The role of the outgoing spiral channel layer (112) in these and other embodiments is to feed the exit port with effluent process water enriched in mineral concentration.

The bottom layer (114) according to various embodiments forms a dome and an containment for the channel set described above. In at least the illustrated embodiment of FIG. 2, the layer is sealed along the sides of the tube of the outgoing spiral channel layer (112). This forms sealed regions around the features on the next layer up to provide thermal isolation of those features. The layer is perforated into a flat tube below. The lower surface may be, in certain embodiments, of food-grade materials. Of course, alternative materials may be selected, as commonly known and understood in the art as being acceptable for particular applications. That being said, in certain embodiments, in a wide and shallow tube (not shown), water flows downhill on a slight grade to provide suction and seawater or process water to be purified for slightly mineral enriched water to mix. As previously described herein, in this matter the cell (100) is “level-able” with some degree of slope such that a “flow” of the water passing there-through is facilitated. In this regard, in certain embodiments, the water may be at the lowest ambient temperature easily available upon entering the cell. In these and still other embodiments, a collection channel (116) may be provided as part of the cell (100), so as to facilitate the routing of freshwater effluent for collection, as will be described in further detail below.

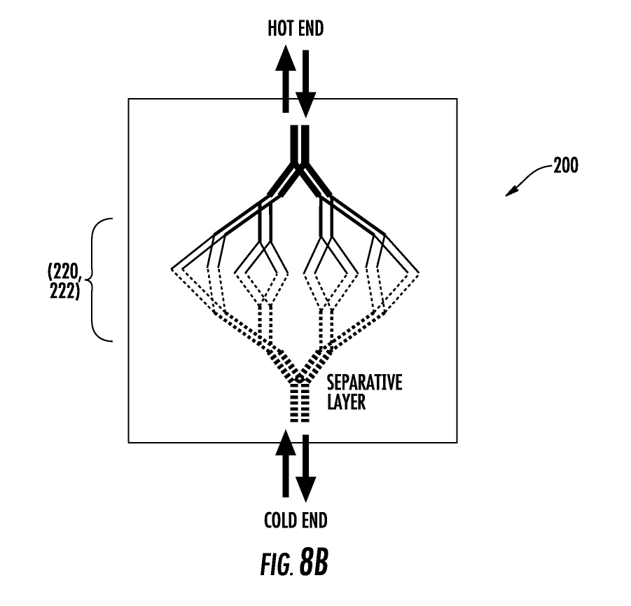

According to various embodiments, the dome formed by the bottom layer (114) thermally insulates the double coil from the surrounding water, which allows for thermal-countercurrent-gradient-flow of water coming into and going out of the processing cell and the associated recapture of the “Heat of Vaporization” energy. Such may be understood with reference to at least FIGS. 8A and 8B, as will also be described in further detail below.

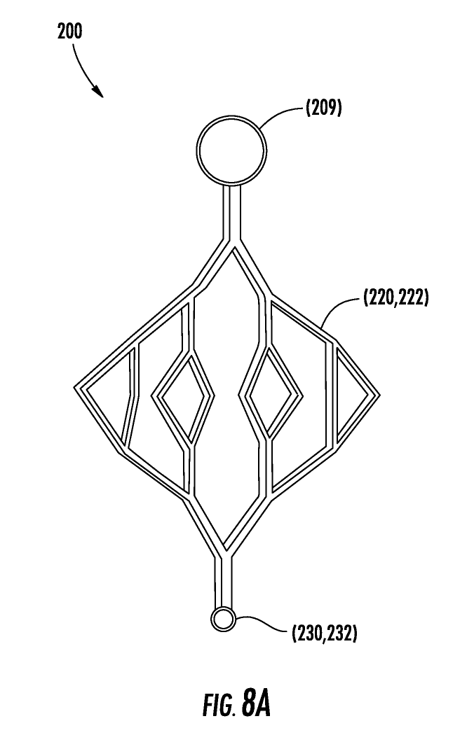

Specifically, remaining with FIGS. 8A and 8B according to various embodiments, various regions of cell (100) may exchange heat when channels of differing temperatures at their respective opposite ends, with a thin barrier between them, approximate physical contact while retaining channel integrity and respective opposite flow directions. Notably, while the ends in these and other embodiments are considered ‘opposite’ because the end of the channel with the incoming flow is in close proximity to the other channel's outgoing flow, the channels with outgoing flow typically share a bounded reservoir with the channels with incoming flow. The reservoir, of course, is bounded and separated only by the membrane layer between the respective channels, as may be understood from FIG. 7. Thus, in these and still other embodiments, the temperatures of the respective incoming and outgoing ends of the channels will approach equality with increasing heat exchange and better thermal contact over longer lengths of the channels. Near the incomings channel's source, the temperature of the incoming water is lower than that of the water vapor in the cell volume above the incoming channel and, as a result, water from that vapor will condense on the colder regions of the channel preferentially.

Returning to FIGS. 8A and 8B, where the water has remained vapor, this condensation will impart the arithmetic negative of the heat of vaporization in amounts proportional to the amount of water that condenses, in the amount of the Heat of Vaporization times the amount of water. The amount of energy expended in the initial evaporation and associated distillation purification can be recaptured in this way when multiplied by an efficiency term. The result is various embodiments of cell (100) may obtain distilled water for the energy losses required by the energy of solution of the solute concentration change and the temperature increase of the effluents, both of the fresh water and the processed salt water, along with any inefficiencies of the configuration. Such will be described in further detail below with respect to additional embodiments, again with particular reference to FIGS. 8A and 8B.

### Various Embodiments of Cell 200

Generally speaking, in various embodiments, a single cell (200) may be provided that is formed from multiple layers in a substantially similar fashion to that of cell (100), as previously described herein. Like cell (100), certain embodiments of cell (200) may comprise a double-layered dome that isolates the system from ambient conditions, while also allowing sunlight to freely enter, for purposes as have been previously described herein and as will be further described below.

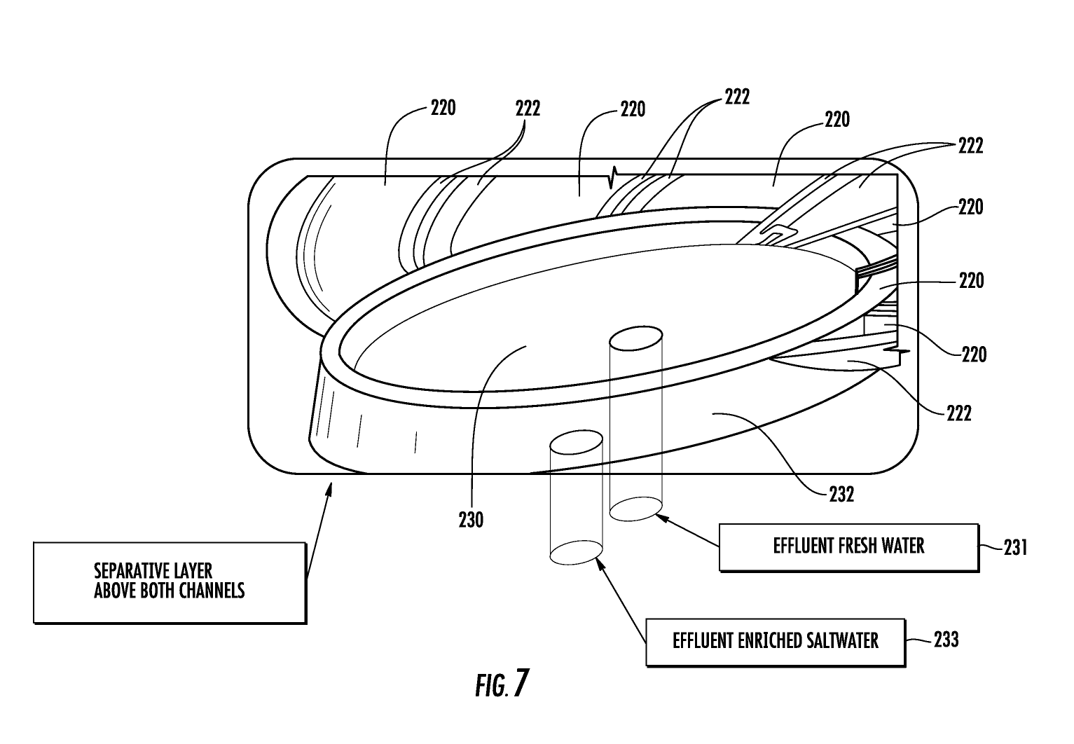

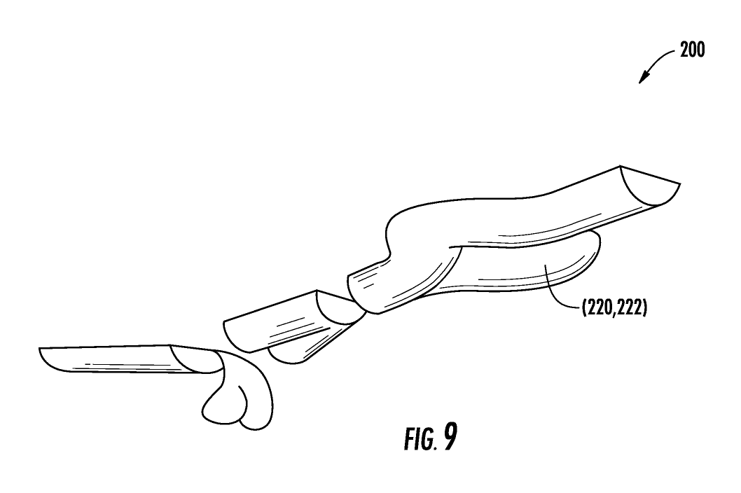

As may be understood with reference to FIGS. 6 and 9, unit cells (200) according to various embodiments may have a series of thin channels entering the unit carrying seawater or other liquid solution, a cup-like container (209) at the center of the unit where the water interacts with the internal atmosphere of the unit, and a plurality of nested and parallel thin dendritic channels (220, 222) existing the unit. In certain embodiments, the nested and parallel thin dendritic channels (220, 222), or dendritic channel counter-current thermal (“TCCF”) exchange system, having an upper channel principally contained by a lower channel, may be configured to carry the effluent of slightly increased salinity or mineralized concentration separately from the condensed freshwater. In at least the illustrated embodiment of FIGS. 6 and 7, the freshwater solution (231) is carried via the upper nested (e.g., TCCF) dendritic channel (220) to an exit port or cup (230), wherein the effluent fresh water may be collected, while simultaneously (although separately) the effluent enriched saltwater (233) is carried via the lower nested dendritic channel (222) to an exit port or cup (232), where it may similarly be collected. It should be understood, however, that any of a variety of dendritically formed channel configurations may be employed, provided the separation of saltwater and fresh water is achieved by the cell (200).

According to various embodiments of the cell (200), a light catching array (e.g., mirror (211) as seen in FIG. 6) may be incorporated to focus energy from external environmental sunlight inside the unit and thus increase internal temperatures more efficiently and effectively. Thus, according to various embodiments, and as will be described in further detail below, sea water (or other mineralized or otherwise “contaminated” water) may be provided to an input of the cell (200), after which evaporated water may be condensed internally to the cell (200), before being channeled via a capillary bed having a series of nested and parallel dendritic channels (220, 222) (e.g., TCCF, as will be described later herein-below) to at least two collection cups (230, 232). It should be understood in these and other embodiments, the precise number and configuration of the dendritic channels (220, 222), including whether they are single or doubly formed or still otherwise, may vary as may be desirable or advantageous for particular applications.

Turning now in particular to FIG. 6, various features of cell (200) that may according to various embodiments substantially differ from those features of cell (100) are illustrated more fully. It should be understood that those features other than those addressed specifically herein may, in certain embodiments, be substantially the same in size, shape, and configuration, as described previously herein with respect to cell (100). As a non-limiting example, for instance, the cell (200) may include a double dome (not illustrated in FIG. 6), substantially the same as that illustrated in FIG. 2 for purposes of describing cell (100). Of course, in still other embodiments, various features may be substantially different that than described in the context of cell (100), even though such may or may not be particularly highlighted herein-below or otherwise.

Returning to FIG. 6, various embodiments of the cell (200) may include a number of layers. An outer dome (not shown, but see by analogy dome (102) of FIG. 2) provides thermal isolation for the cell (200). An inner dome (again, see by analogy dome (104) of FIG. 2) forms an evaporative containment vessel. The inner dome layer, like that previously described herein in the context of cell (100) may, in certain embodiments, be thermally insulated from airflow above the cell (200) by the outer dome. Some embodiments that are used in environments where external convection is low, such as areas with typically low winds, may only need a single layer dome, as may be acceptable of desirable for particular applications. As the skilled person realizes, the insulating layer formed between any of the various configured outer and inner domes involves, amongst other things, a trade-off between these effects and reflective losses due to multiple surfaces. Idealized insulation values are dictated by the type of gas that is used between the outer and the inner domes, as likewise previously described with regard to cells (100). Of course, for whatever reason, still other embodiments may dispense entirely with any form of domes (see e.g., FIG. 6), where such may be desirable.

That being said, according to various embodiments, the double-dome structure of cell (200) allows pre-heating of the cell to preclude condensation energy losses therein. This preclusion of convection cooling on the internal surface exacerbated by air movement in the absence of the external dome is considered herein to be a preferable trade-off against the alternative of any losses incurred by the necessitated heating of the interstitial space between the two domes in those embodiments having such a configuration. An additional feature of this approach is that it automatically changes the cell's (200) volume and thereby its natural water level. This feature can be supplemented in certain embodiments by similar sealed air bladders below the operating waterline not only to perform the thermal isolation of coils, as will be discussed below, but in order to flush accumulated minerals when the cell cools at night and the water level rises to above the operating height by increasing the head or by decrease in buoyancy. Of course, these features were likewise described above with regard to cell (100), and it should be understood that to the extent not addressed explicitly herein, certain features of cell (200) may be substantially the same as that found in cell (100).

As may also be understood from FIGS. 6 and 7 collectively, an evaporative structure (not shown, but which may at least in part incorporate column (208) in certain embodiments) is provided within the interior of the cell (200) according to various embodiments. In certain embodiments, the evaporative structure may be porous, water insoluble, made of food-grade materials, and capable of sustained temperatures approaching and/or exceeding 100 degrees centigrade. Other embodiments may use calculated target temperatures achieved substantially lower than 100 C or may use open water approaches not involving an evaporative surface area enhancer, which may reduce mineral salt deposition. In still other embodiments, target temperatures may be any of a variety of temperature at, below, above, or even far exceeding the aforementioned 100 degrees centigrade, as may be desirable for various applications.

According to various embodiments of cell (200), an incoming dendritic channel layer (210) may be provided, as illustrated in at least FIG. 6. The dendritic channel has a configuration that is the same as that of a set of paired outgoing dendritic channels (220, 222) in the outgoing channel layer below (see also FIG. 7). The incoming dendritic channel is principally contained by the outgoing channels below, except at its endpoints on the output end which terminate outside the thermal containment bubble created by layer below when present on the cellular level, and of the end closest to the center of the cell which terminates in an opening onto the bottom of the central cup (209). Since the top of the incoming water channel serves as the bottom of the condensation chamber (e.g., forms a ceiling/floor relationship between layers), a thermal exchange boundary is created in these and still other embodiments. By forming a dendritic configuration (see also FIGS. 8A and 8B0 of input water thermally interfacing with the floor of the condensation chamber, the temperature of the cold, incoming water is raised jointly by condensation on the interface and post processes effluent temperatures exposure.

Returning to FIG. 6, according to various embodiments, below the incoming dendritic channel layer (210) is an plurality of paired outgoing dendritic channel layers (220, 222), which form the respective outgoing channels by means of a dendritically-shaped “web,” as may further be understood with reference to FIGS. 8A and 8B. The role of the outgoing dendritic channel layers (220, 222) in these and other embodiments is to feed the perforation and exit port/cup (232) with effluent process water enriched in mineral concentration, while at the same time filtering out separately effluent fresh water for channeling to exit port/cup (230), all as illustrated in FIG. 6 and as will be described in further detail below.

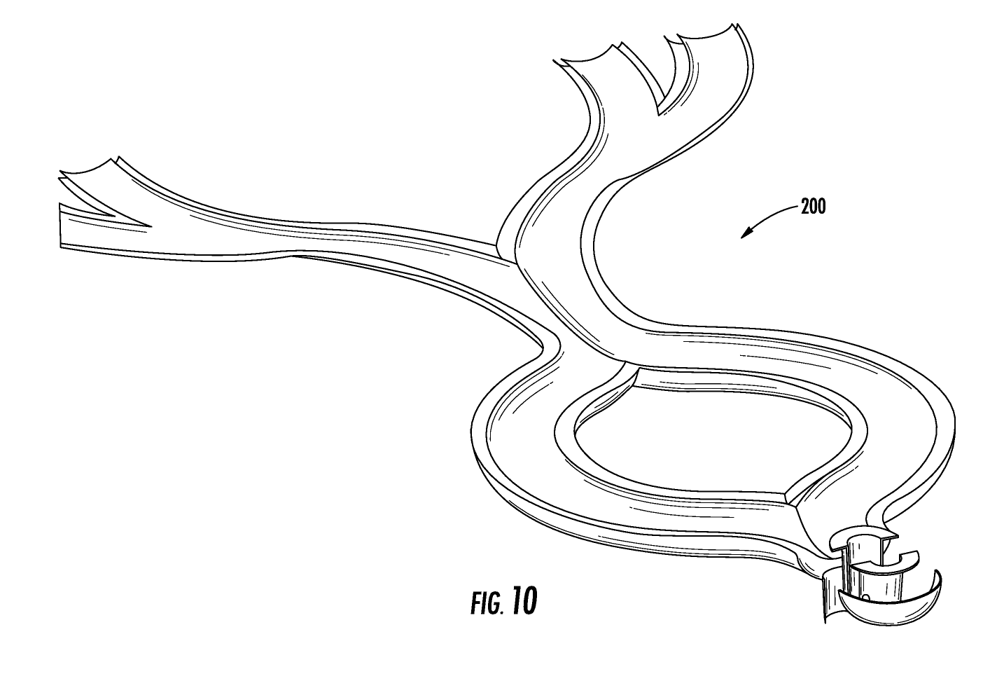

Various embodiments of cell (200), much like cell (100) may incorporate one or more collection channels (e.g., 220, 222), which may be dendritic in shape and configuration. In certain embodiments, the cup (209) below the column (208) and layer (210), as described above, is configured to pass water into and through a plurality of paired and nested lower dendritic channels (220, 222). In certain embodiments, because of a pressure imposed by the incoming water, and because of a vacuum created by the water flowing ahead of it, the water flows naturally, while in other embodiments, the cell (200) may be placed on a slight gradient to further facilitate flow, as may be understood with cross reference to FIGS. 9 and 10. It should further be understood that while the slight gradient may be downwardly oriented in certain embodiments, thereby taking advantage of gravity, other embodiments may be upwardly oriented, based upon a variety of parameters including, for example, the pressure gradient within the cell, as will be described in further detail below.

Returning to the pressure gradient, it should be understood that according to various embodiments the pressure imposed may be further increased with the evaporation of the water itself, as it is exposed to solar energy. As such, the water will condense preferentially on the coldest available areas, as may be also seen in at least FIGS. 8A-8B. In these and still other embodiments, input water may be selected at a minimum temperature available so as to maximize the benefit of this and still other effects. Notably, as water of a lower temperature than will be achieved in the cell (200) will generally be naturally available, such will not impose an additional cost upon the operation of the cell (200).

In any event, according to various embodiments, cell (200) may be further configured to rout condensed water by gravity and cell geometry to the lowest point of the nested dendritic channels in the cell (200), which, as may be understood with reference to FIGS. 6 and 7, may consist of the freshwater and effluent enriched cups (230, 232). As that location, effluent fresh water solution (231) and effluent enriched saltwater (233) (or mineralized brine) may be collected for further subsequent use and/or transport. Notably, it is the nested and series configuration of the dendritic channels (220, 222) that facilitates the delivery of the separate water solutions in this efficient and effective manner.

It should be noted that according to various embodiments the lowest point is further in the vicinity of the influent as this is where the temperature is the lowest in the cell, as may also be understood with reference to FIGS. 8A and 8B. In this regard, in certain embodiments, a thermal-countercurrent-gradient-flow of water (see again FIGS. 8A-B) coming into and going out of the processing cell and the associated enable the recapture of the “Heat of Vaporization” energy. In this manner, various regions of cell (200) may exchange heat when dendritic channels of differing temperatures at their respective opposite ends, with a thin barrier between them, approximate physical contact while retaining channel integrity and respective opposite flow directions. Notably, while the ends in these and other embodiments are considered ‘opposite’ because the end of the channel with the incoming flow is in close proximity to the other channel's outgoing flow, the channels containing outgoing flow typically share a bounded reservoir (as previously described herein) with the channels containing incoming flow. Thus, in these and still other embodiments, the temperatures of the respective incoming and outgoing ends of the channels will approach equality with increasing heat exchange and better thermal contact over longer lengths and greater surface areas of the channels. Near the incomings channel's source, the temperature of the incoming water is lower than that of the water vapor in the cell volume above the incoming channel and, as a result, water from that vapor will condense on the colder regions of the channel preferentially.

Where the water has remained vapor, this condensation will impart the arithmetic negative of the heat of vaporization in amounts proportional to the amount of water that condenses, in the amount of the Heat of Vaporization times the amount of water. The amount of energy expended in the initial evaporation and associated distillation purification can be recaptured in this way when multiplied by an efficiency term. The result is various embodiments of cell (200) may obtain distilled water for the energy losses required by the energy of solution of the solute concentration change and the temperature increase of the effluents, both of the fresh water solution and the processed salt enriched brine, along with any inefficiencies of the configuration.

### Operation of Various Embodiments

### Operation of Various Embodiments of Cell 100

According to various embodiments, the water flow through a single cell (100) will now be discussed. In certain embodiments, the water flows by gravity, pressure, or otherwise through an aperture on the top surface of the cell into the top channel (110) of the thermally contacting spirals. The water may then, according to these and other embodiments circulate around the central cup (108) on a spiral of decreasing radius until it arrives at the cup (108). The water then fills, or partially fills, the cup (108), where evaporation occurs at an increased rate by virtue of the temperature increase both from being in thermal contact with the water that is about to leave the cell (100) and due to condensation on to the colder regions of the spiral channels, as previously described herein.

Subsequently, according to various embodiments, the water leaves the cup (108) through the lower channel (112) because of a pressure imposed by the incoming water, and because of a vacuum created by the water flowing ahead of it. In certain embodiments, it should be understood that the pressure imposed may be further increased with the evaporation of the water itself, as it is exposed to solar energy. As such, the water will condense preferentially on the coldest available areas. In these and still other embodiments, input water may be selected at a minimum temperature available so as to maximize the benefit of this and still other effects. Notably, as water of a lower temperature than will be achieved in the cell (100) will generally be naturally available, such will not impose an additional cost upon the operation of the cell (100).

In any event, according to various embodiments, the water that condenses is routed by gravity and cell geometry to the lowest point in the cell (100). In certain embodiments, the condensed water then passes through to an exit port dedicated to freshwater extraction. Water condensing onto warmer areas of the chamber floor will be accordingly warmer, and varying relative flow rates can be used to dictate effluent temperatures. It should be understood of course, that effluent removed from the condensed water within the cell (100) may be, according to various embodiments, routed to a different port for exiting the cell, thereby separately handling the freshwater and effluent so as to avoid inadvertent cross-contamination thereof

### Operation of Various Embodiments of Cell 200

According to various embodiments, the water flow through a single cell (200) will now be discussed. In certain embodiments, the water flows by gravity (e.g., the slightly or otherwise tilted” configuration of cell (200) as previously described herein) through an aperture on the top surface of the cell into the top channel (210) of the thermally contacting dendritic channels. The water may then, according to these and other embodiments circulate to the central column (208) until it arrives at the cup (209). The water then fills, or partially fills, the cup (209), where evaporation occurs at an increased rate by virtue of the temperature increase both from being in thermal contact with the water that has already left the cup (209) and due to condensation on to the colder regions of the dendritic channels, as previously described herein.

Subsequently, according to various embodiments, the water leaves the cup (209) through the plurality of paired and nested lower dendritic channels (220, 222) because of a pressure imposed by the incoming water, and because of a vacuum created by the water flowing ahead of it. In certain embodiments, it should be understood that the pressure imposed may be further increased with the evaporation of the water itself, as it is exposed to solar energy. As such, the water will condense preferentially on the coldest available areas, as may be seen in at least FIGS. 8A-8B. In these and still other embodiments, input water may be selected at a minimum temperature available so as to maximize the benefit of this and still other effects. Notably, as water of a lower temperature than will be achieved in the cell (200) will generally be naturally available, such will not impose an additional cost upon the operation of the cell (200).

In any event, according to various embodiments, the water that condenses is routed by gravity and cell geometry to the lowest point of the nested dendritic channels in the cell (200), which, as may be understood with reference to FIGS. 6 and 7, may consist of the freshwater cup (230) or effluent channel. Such according to various embodiments is in the vicinity of the influent as this is where the temperature is the lowest in the cell, as may also be understood with reference to FIGS. 8A and 8B.

In certain embodiments, the condensed water then passes through to an exit port (not shown in FIGS. 6 and 7, but understood from at least FIGS. 9 and 10) dedicated to freshwater extraction. Water condensing onto warmer areas of the chamber floor will be accordingly warmer, and varying relative flow rates can be used to dictate effluent temperatures. It should be understood of course, that effluent removed from the condensed water within the cell (200) may be, according to various embodiments, routed to a different point and/or exit port for exiting the cell. With reference against to FIGS. 6, 7, and 9, such may consist of, in certain embodiments, at least the effluent cup (232) and an associated effluent exit port (also not shown). In this manner, the cell (200) is configured to collect and separately handle the freshwater and effluent so as to avoid inadvertent cross-contamination thereof.

### Scalable Arrays of a Plurality of Cells 100/200

### Various Embodiments of Arrays

According to various embodiments, once the optimal particulars of individual cells (100, 200) are identified, arrays or systems of a large number of small cells (100, 200) can be constructed with large sheets of the laminar materials to get a scalable production system with good yield. In certain embodiments, fresh water drainage networks interconnecting several cells (100, 200) can be constructed in both rectilinear and hexagonal packing arrangements. In other embodiments, any of a variety of arrangements may be chosen, as may be desirable for particular applications. In this manner, any individual cells (100, 200) considered to be leaking, according to various embodiments, between fresh and saline waters can be blocked as desirable, thereby increasing the purity of the effluent, although also decreasing the amount of production. It should be understood that such, however, may be beneficial, as production may not need to be entirely suspended for the repair and/or maintenance of less than all of the cells (100, 200).

FIGS. 3A-C show various views of an exemplary embodiments of a cell array (300), which may be formed from a plurality of small cells (100, 200), in accordance with various embodiment of the invention. FIG. 3A is a top elevation view of the array (300) of cells (100, 200) in accordance with one embodiment of the invention, which reveals not only how individual cells may be positioned adjacent one another so as to maximize production and efficiency per unit of area, but also how certain cells may be adjoined such that they share at least one common wall, as will be described in further detail below. These and other features will become more apparent; however, it should be understood that the illustrated embodiment of FIG. 3A is intended as exemplary and should in no way be construed in a limiting fashion.

Turning now to FIG. 3B, a vertical cross sectional view of the array (300) according to various embodiments may be seen. When viewed in conjunction with FIG. 3C, which is a top view of the array (300), it should be understood that although the cells (100, 200) in the array (300) shown in these figures are arranged in a hexagonal pattern, the cells (100, 200) can be arranged in any suitable pattern, such as a rectilinear, a triangular pattern, an octagonal pattern or any other geometry that may provide convenient interconnections of cells and a desired yield of decontaminated and/or desalinated water over a maximized active area of the array (e.g., an optimized fill factor).

As is generally known and understood in the art, elevated temperatures decrease the solubility of some minerals causing precipitation of mineral salts. These mineral are again soluble at the lower temperatures experienced at night. These characteristics can be exploited by a decrease in the buoyancy of the cell (100, 200) and/or array (300) according to various embodiments. Such may be accomplished, for example, by incorporating within the cell (100, 200) and/or array (300) materials whose volume changes by virtue of changes in their associated temperature. As yet another non-limiting example, the coefficient of expansion of a gas can be used to affect and, in turn, control the flow rate and/or the water level in the cell (100, 200) so as to either increase or decrease the surface area of the interface, as may be desirable for particular applications. Similarly, these and still other embodiments may control (e.g., either directly or indirectly via control of other parameters, as described elsewhere herein) the volume available for the resolution of the salts, thus reducing the need for various conventional descaling agents.

In various embodiments, the nested spiral or dendritic TCCF layers and the layer forming the floor of the upper channel are physically fused at the contacting surfaces, thus providing controlled relative channel cross sections. The primary exploited mechanism of these and still other embodiments is thus the exploitation of the change in concentration of the salts in the effluent solution. The associated entropy, free energy, and heats of solution changes between the three open bodies of water provide substantial offset of the terms as received from the sun's radiation. In this manner, according to these and still other embodiments, these terms enable a dramatic increase in production in an otherwise energy conservative system.

According to various embodiments, a maximum number of cells (100, 200) can be arrayed on a single channel of constant cross section and a given pressure, so as to nearly approximate the water “head” or height of the source water above the height of the systems target reservoir. It should be understood that in these embodiments, the maximum number may be any of a variety of actual values, as may be calculated as advantageous, desirable, or practical for particular applications. However, in any of these and still other embodiments, the maximum number of cells (100, 200) under these conditions thus dictates the need for channels or ancillary plumbing periodic distances or spacing to support collection of the fresh water produced.

The height of the cells (100, 200) may also, according to various embodiments, be varied to accommodate different flow rates through the cellular array (e.g., 300), depending on the temperature of the interior of each of the cells and the current weather. Of special interest to both individual cells and arrays of cells in these and still other embodiments, is the height of the water on the top surface of the layer containing the cup (e.g., 108, 209). The height of the incoming water surface height must be below that of the top edge of the cup (108, 209) so as to prevent overflow if no overflow drainage port exists. In this regard cell and array flooding and cross contamination of fresh water effluent is facilitated by maintaining a functional exit channel flow capacity in excess of that of the incoming channel. In suspended arrays this is compensated for by lengthening and/or varying the relative cross sections and aperture sizes of the fresh and enriched waters' effluent tubes.

In some embodiments suitable for applications in dams and buildings and other similar contexts, the cup (108, 209) edge may be rotated so as to operate in an inclined or configuration, oftentimes relative to a support surface (e.g., the ground). Extended lengths of this approach may need ancillary flow control to compensate for the implicit increase in ‘head’ or vertical water column, but essentially all other aspects of the geometry, as described above, can be left intact. In certain embodiments, this may be accomplished by a plurality of open cascades, each forming only localized ‘head,’ as may be desirable for particular applications.

In at least one embodiment, the minimum number of cells (100, 200) and size of water body required (whether directly accessed and in contact with, or supplied via conventional or other plumbing means) to produce one million gallons of fresh water a day can be determined as follows, which is included for purposes of illustration and should not otherwise be construed as limiting in nature. For purposes of this example, it is assumed that the cell (100, 200) diameter is approximately six centimeters, and that the production time is about 6 hours (i.e., there are 6 hours of sufficiently strong sun light for the array of cells to work as described above. (1.2×10⁻³ cc/s)⁻¹*1.7528×10⁵ cell*cc/s=1.46×10⁸ cells. The size of the water production area would be 1.46×10⁸ cells*0.064 m*0.1 m=9.3×10⁵ m²=0.36 sq mile=230 acres. It should be noted that these numbers may vary depending on weather conditions, size of cells, selection of materials, and so on.

It should also be understood that these numbers may vary upon the varying features (e.g., spiral versus dendritic) amongst different embodiments of cells (100, 200). However, as a general run of thumb, in practice, it should be understood that approximately 200 acres of water surface area is expected to be needed to generate a million gallons of water per day in most of the various disclosed embodiments. That being said, in certain embodiments, it may take substantially less than or even substantially more than 200 acres of water for such a degree of production, dependent not only upon cell characteristics, but also ambient and environmental factors, as previously described herein.

### Alternative Uses of Arrays and/or Cell Embodiments

The previously and subsequently described embodiments herein may avail many other uses than for direct water production. As non-limiting examples, greenhouse designs using arrays allow for the growth of plants in the interior of the green house for either food production. As such, various systems meant for carbon dioxide (CO2) scrubbing may be placed in areas of high carbon dioxide concentration and flow with large volumes of atmospheric gases blown by fan action into the greenhouse to allow the botanical filtration of the gas by the plants. Additionally, closed cell embodiments where the outgoing enriched effluent spiral and/or dendritic tube (as however may be the case depending on if cell 100 or cell 200 is employed), is omitted. In these and still other embodiments, such a configuration allows for mineral capture in applications such as the non-limiting examples of mine or agricultural wastewater clean-up.

As mentioned, a number of implementations and uses of the various embodiments of arrays and/or individuals cells have been described herein above, and also further below. Nevertheless, it should be understood that various modifications may be made without departing from the spirit and scope of the invention. For example, the materials that were used in the above examples are merely suggestions and other materials may be more suitable for other applications. Such modifications to the above description fall within the skill of the ordinary artisan. The incoming and outgoing spiral and/or dendritic channels do not have to be spirals or dendritic in shape. There are a number of other geometrical patterns that may be used, as may be more advantageous and/or desirable for particular applications.

### Additional Features of Cells 100, 200 and Associated Arrays

### Various Flow Controls

According to various embodiments, it may be desirable to maintain the maximum temperature supportable by the heat exchange system of cells (100, 200). Such, amongst other benefits, ensures maximum effectiveness and efficiency of not only the cells, but their associated arrays and/or systems. In certain embodiments, flow control is central to maintaining the maximum temperature supportable by the heat exchange system. As a non-limiting example, maximizing channel and core water latency directly corresponds to the temperature achieved. Channel and core water latency is, of course, offset with and balanced by the enriched effluent's temperature. As such, according to various embodiments, the maximum output of a given cell may be generally defined as a function of the area under the time-at-temperature curve for any given influent water temperature. Thus, the flow initiation and subsequent increase and moderation are generally dictated by the cell's inherent operating curve for a given exposure.

### Various Geometric Considerations

i. Concave Channels

Various embodiments may incorporate concave channels for surface area and directed drainage. In certain embodiments, various means are available for rendering the top surface of the channels ‘concave-up,’ thereby increasing their respective surface area. This, amongst other benefits, instills a gravitational tendency in the condensed waters present according to various embodiments, to aggregate in the bottom of the formed trough in such a manner that the condensed drops are already angled in a compound angle with respect to that same gravity. In this manner, these and still other embodiments may be configured to facilitate and to promote flow toward the fresh-water effluent duct.

It should be understood that patterns may be printed either prior to channel formation or after channels have already been formed. The types of patterns anticipated are similar to ferns or leaves from the botanical world or other fractal geometries, with the source of the branching terminating either toward or in the bottom of the channel, or at or toward the freshwater exit port. These patterns are hydrophobic-hydrophilic media, arranged on heat exchangers condensation surface, which may, according to various embodiments, exploit the polar nature of the water molecules. Such exploitation, in these and other embodiments, may facilitate condensation through increased functional surface area and designed flow generating orientations. While such embodiments are described in further detail herein below, it should likewise be understood that still other embodiments may comprise substantially different types of patterns, as may be desirable for particular applications.

ii. Common Walls

According to various embodiments, rows of adjacently positioned cells (100, 200) may be configured with common walls for improved thermal contact and/or input channel formation. In these and still other embodiments, the rows of cells (100, 200) joined at several of their boundaries provide not only convective insulation to their neighboring cells, but also provide an improved ability to reach radiative equilibrium, such that radiated energy from neighboring cells outgoing and incoming cancel on the shared surface by virtue of their comparable temperatures. In this manner, the efficiency and effectiveness of various embodiments of the cells (100, 200) may be influenced by the manner in which adjacent cells are positioned and/or joined. Of course, it should be understood that any of a variety of commonly shared interfaces may be configured between adjacently positioned cells (100, 200), as may be desirable for particular applications, and such should likewise be considered within the scope of the present invention.

iii. Branching Structures and Surface Area

Still further, according to various embodiments, complex branching structures with increased surface area and drainage may be incorporated within cells (100, 200), as previously described herein. As a non-limiting example, the tuned dendritic structures, as previously described, in contact with not only condensation surfaces but also with one another may provide enhanced surface area for thermal exchange. In these and still other embodiments, such branching structures and configurations may also provide favorable drainage gradients for facilitating improved flow to the freshwater exit port, as previously described herein. Of course, various options exist, as may be desirable for particular applications, but may include optimizing branch counts, varying cross-sections, and/or modifying lengths for heat-flow, depending on observed or desirable total cell water volume and exposure.

iv. Gooseneck on Effluents

In various embodiments, total cell water volume and other heat loads impact cell temperature attack rate and final temperature achieved by the cells (100, 200). As such, in these and other embodiments, water volume and heat loads are a primary metric in determining the overall cell efficiency and freshwater production. Minimization of mass internal to the cell, whether in the form of internal mirrors, internal water containment column, and/or internal water mass present at a given moment, all as previously described structurally herein, each contribute to the functional heat load whose total mass must be warmed in order for the cell to operate. Accordingly, it is desirable to minimize total mass to maximize cell (100, 200) efficiency and effectiveness, to various extents, as may be desirable for particular applications.

As a non-limiting example, in various embodiments, simply halving the mass of the reflector (e.g., mirror), which is typically the largest element in the interior of the various cell modules, will cut the heat load of the system as a whole, approximately in two. Concurrently, in these and other embodiments, halving the combined heat load of the system will, in turn, double the attack rate and the temperature achieved. Likewise, for any two given configurations that are in all other physical and flow rate parameters identical, if one has half the water mass inside the system at a given time to heat, dictates faster temperature rise of that water.

v. Closed Venting to Condenser Surface

A practical means of reducing the volume into which water is vaporized and directing the vapor flow directly to the condensation surface is to contain the top surface vapor pocket of the heated water in the core of the system. In manner, according to various embodiments, the vapor may be precisely directed to the top surface by passive transport, which in certain embodiments may be further mediated by the generating pressure of the vapor and/or the generated relative vacuum at the condensation surface. Various embodiments having this configuration allow for the optional omission of the mirror system (as previously described herein) from the cell interior. As such, in these and still other embodiments, the associated heat load of the mirror system is removed, inherently improving the efficiency and effectiveness of the system in at least these and possible other embodiments. It should be understood, of course, that in these and still other embodiments, the water column evaporative structure's output passes directly to the condenser elements of the system, as compared to the passage which occurs in those embodiments incorporating the mirror system, as previously described herein.

Lateral linkages between cell elements in row structures with common head height provide by a shared channel between rows. Functional cell pressure generated by water column presented by water flowing in channels on the input side of the cell allow for rows to share feed pressure equalizing flow rates through the cells in that row.

vi. Vertical Systems

According to various embodiments, cascades of overflowing reservoirs may be arranged to present locally controllable water columns for the introduction of influent into rows of cells deployed on a vertical surface. The internal structural modifications to the cell according to these embodiments may comprise at least of tilting the water column tube off perpendicular with respect to the floor. In these embodiments a similar rotation of the reflector to maintain the focal bundle on the center core may be likewise provided. In this manner, in these and still other embodiments, the core tube is moved closer to the exit port for clearance and this causes wide dendritic beds.

Still further, trough-type reflectors can be employed according to various embodiments so as to prolong the high performance period during the diurnal cycle. The general solution to this approach, within the constraints of various embodiments of the system, suggests thermally connecting the longitudinal axis of the reflective collector to the evaporative tube. Such configurations may be achieved, for example, by affixing a conductive wire or sheet to the evaporator tube along that axis. Of course, further refinement of the central column to incorporate a two branched tube proceeding along the reflective axis of the reflector and returning to the evaporative cup for exposure to the condensing region and subsequent reintroduction to the exit path heat exchanger may also be beneficial in certain of these and still other embodiments. However, it should be understood that alternative features and/or configurations in this regard may be beneficial or desirable for particular applications or scenarios, and as such should be considered within the scope of the present invention.

### Various Surface Treatments

According to various embodiments, additional dendritic exchange surfaces can be constructed using conventional micro-circuit printing methods either prior to channel formation or after channels have already been formed. Such provides enhanced exchange characteristics, including linear functionality, surface heat exchange, and volumetric capabilities. In these and still other embodiments, the types of patterns anticipated are similar to ferns or leaves from the botanical world or other fractal geometries, with the source of the branching terminating either toward or in the bottom of the channel, or at or toward the freshwater exit port. It should be understood, however, that any of a variety of patterns, shapes, and configurations may be incorporated to form water courses in hydrophobic-hydrophilic media arranged on the channel surfaces and/or their associated heat exchangers.

### Methods of Testing the Efficacy of Cells 100, 200 and Associated Arrays

According to various embodiments, it may be desirable or advantageous to periodically or otherwise perform tests upon the cells (100, 200) and/or their associated arrays, so as to ensure a certain degree of performance, integrity, and efficiency is maintained. Such testing may also monitor and/or provide notifications for routine maintenance of the cells (100, 200) and arrays, or even capture otherwise unknown cell/array failures, whether due to external environmental conditions, material property defects, or otherwise. As is commonly known and understood in the art, such test procedure may be extremely valuable and thus worthwhile to perform on a regular basis.

In certain embodiments, equipment used for evaluating and testing the efficacy of the cells (100, 200) and/or their associated arrays may include the non-limiting examples of thermometers or thermal imagers or probes, salinity meters, flow regulators, and a connection station for internal sensors. Such equipment will generally provide a reasonable level of resolution and accuracy that will provide a desirable scope of data, with specifications for resolution and accuracy. It should be understood, of course, that any of a variety of equipment, monitors, sensors, and the like may be employed, as may be desirable for testing or monitoring a particular variable for a particular application.

In various embodiments, one or more features of the cells (100, 200) may further be varied for purposes of testing and/or experimentation. For example, columns of different sizes, different color (e.g., black, clear, etc.) bottoms, different color (e.g., black, clear, etc.) channels, and/or an optional bottom dome (or lack thereof) may be interchanged, as may be desirable for a particular application or scenario.

### CONCLUSION

It should be understood that advantageous implementations according to various embodiments can include any of a variety of the previously described features. In any of these and still other embodiments, mineral-containing water can be pumped into the module and cells (100, 200) to fill the first and second channels and reservoir and control the throughput of water. In this manner, various embodiments may be implemented in a highly controlled, efficient, and effective manner, and further result in predictable and beneficial environmental impacts. Still further, in certain embodiments, the apparatuses, devices, modules, and cells (100, 200) described herein can be made from any of a variety of materials, whether recycled materials or otherwise and the devices and apparatuses themselves may likewise be recyclable.

Still further, various embodiments may be used with minimal training, the user cost is minimal, they are inexpensive to manufacture, and generally do not require any extensive degree of maintenance. In addition to being used for seawater desalination and water purification, various embodiments of the devices can also be used for atmospheric carbon dioxide scrubbing, industrial and mining cleanup and food production. It should also be understood that various embodiments are extremely scalable, such that they are compatible with large scale infrastructure, as may be desirable for particular applications, while also remaining capable of being appropriately sized and scaled so as to be suitable for a single individual or family.

As such, it should be understood that the foregoing description of the various embodiments of the present invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention and should be interpreted in accordance with the breadth to which they are fairly, legally and equitably entitled. The drawings and preferred embodiments do not and are not intended to limit the ordinary meaning of the various embodiments in their fair and broad interpretation in any way.

What is claimed is:

1. A modular apparatus for the evaporation and demineralization of water to provide at least partially demineralized water by utilizing latent heat of condensation and solar heating for energy of vaporization, comprising:
a multilayer module having one or more parameters controllable with respect to a body of mineral containing water, the module comprising:
a first dendritic liquid receiving channel having an entrance port in communication with the exterior of the module, the entrance port being oriented so as to drain toward an exit drain with minimal channel angle with respect to the exit drain;
a second dendritic liquid receiving channel in heat exchange relationship with the first dendritic liquid receiving channel, the second dendritic liquid receiving channel being oriented so as to drain toward an exit drain with a channel angle with respect to the exit drain; and
a dome above the reservoir enclosing the reservoir and forming a vaporization chamber having an inner domed condensation surface and a lower condensate-collecting surface, the condensate-collecting surface having an exit drain in communication with a collection channel for conducting demineralized condensate out of the module,
wherein at least the first dendritic liquid receiving channel is in thermal contact with a riser on the focal axis of the modular apparatus.

2. The modular apparatus of to claim 1 comprising a plurality of the modules.

3. The apparatus of claim 2 wherein the collection channel from each of the modules is in communication with a common collection channel to collect condensate from the apparatus.

4. The modular apparatus of claim 1, wherein at least a portion of the multilayer module has one or more of the following properties: water insolubility, made of food grade materials, and a capability to withstand temperatures in excess of 100 degrees centigrade.

5. The modular apparatus of claim 1, wherein the multilayer module further is operable to be placed at a maintainable height with respect to the surface of the body of mineral-containing water.

6. The modular apparatus of claim 1, wherein the height is such that the top surface of the module may be covered with a controllable water column.

7. The modular apparatus of claim 5, wherein the multilayer module further is operable to be suspended above an effluent stream.

8. The modular apparatus of claim 1, wherein the multilayer module further comprises:
an at least partially evacuated upper chamber above the dome containing air or gas insulating the dome from the air environment; and
an at least partially evacuated lower chamber containing air or gas insulating the first and second dendritic liquid receiving channels from the water environment below the module.

9. The modular apparatus of claim 1, wherein at least one of a hydrophobic and a hydrophilic pattern are formed on a condensation surface positioned above at least one of the first and the second channels

10. The modular apparatus of claim 1, wherein the time and solar exposure dictated flow control is based upon at least:
the dry operating temperature profile so as to maximize the time-temperature of the evaporative column; and
the reservoir to utilize the temperature difference between the incoming water temperature and the column temperature.

11. A solar powered desalination apparatus for reducing the salinity of salt water, said apparatus comprising:
a first membrane layer; and
a second membrane layer, wherein the first membrane layer is contacting the second membrane layer thereby forming a plurality of channels, including a first channel and a second channel,
wherein:
said first channel is configured to receive said salt water for desalination;
a first area connected to said first channel is configured to increase the temperature of said salt water so as to cause evaporation of said salt water upon said first area being exposed to solar generated light; and
said second channel comprises a first portion and a second portion, the first portion configured to convey condensed water having a higher salinity from said evaporation of said salt water and said second portion configured to convey condensed freshwater.

12. The solar powered desalination apparatus of claim 11, wherein at least one of the first and the second channels are dendritically shaped.

13. The solar powered desalination apparatus of claim 11, further comprising a plurality of modules, each module comprising respective first membrane layers, second membrane layers, first channels, and second channels.

14. The solar powered desalination apparatus of claim 13, walls of neighboring modules are in contact with one and other so as to form shared containment via at least one common wall.

15. The solar powered desalination apparatus of claim 11, wherein the first channel and the second channel form parallel and nested dendritic channels.

16. The solar powered desalination apparatus of claim 15, wherein the parallel and nested dendritic channels comprise a counter current double dendritic formation.

17. The solar powered desalination apparatus of claim 11, wherein the first membrane layer seals the top of the first channel and forms a condensation surface.

18. A process for the evaporative demineralization of mineral-containing water comprising:
placing at least one module exposed to the sun or other source of radiant energy into at least associative contact with a comparatively cold body of mineral containing water, whereby an evaporation cycle is performed by:
allowing a portion of mineral-containing water to flow into a first dendritically formed liquid receiving channel and into the reservoir and to flow from the reservoir into a second dendritically formed liquid receiving channel until the water level in the reservoir rises and blocks or reaches the exit port of the first dendritically formed liquid receiving channel;
allowing water in the reservoir to be heated by radiant energy radiating through the dome into the evaporation chamber causing water in the reservoir to evaporate, condense on the condensing surface, collect on the floor of the chamber's capillary bed channeled surface, and flow into the exit drain to fill the collection channel whereby condensate exits the module and the filling of the collection channel blocks or is assisted in exiting exit of vapor's flow by virtue of its flow, from the evaporation chamber;
introducing higher concentration mineralized water in the reservoir during evaporation proceeding as effluent to flow into the second dendritically formed liquid receiving channel and out of the module through the exit port in communication with the exterior of the module below the reservoir; and
during flow of mineral-containing water and effluent into and from the module, the first and second dendritically formed liquid receiving channels are continuously filled respectively with mineral-containing water and effluent in heat exchange relationship as the evaporation cycle is repeated within the module and demineralized water is continuously collected through the collection channel.

19. The process of claim 18, wherein mineral-containing water is pumped into the module to fill the first and second channels and reservoir and control the throughput of water.

20. The process of claim 18, wherein the time and solar exposure dictated flow control is based upon at least:
the dry operating temperature profile so as to maximize the time-temperature of the evaporative column; and
the reservoir to utilize the temperature difference between the incoming water temperature and the column temperature.
